(19) United States
(12) Patent Application Publication
(10) Pub. No.: US 2013/0273843 A1
(43) Pub. Date: Oct. 17, 2013

(54) Method and Apparatus for Near Field Communication Commerce

(71) Applicants: James A. Shimota, Chicago, IL (US); Lawrence Lien, Los Altos, CA (US); Howard E. Levin, Oak Park, IL (US); Kenneth H. Bridges, Palo Alto, CA (US)

(72) Inventors: James A. Shimota, Chicago, IL (US); Lawrence Lien, Los Altos, CA (US); Howard E. Levin, Oak Park, IL (US); Kenneth H. Bridges, Palo Alto, CA (US)

(21) Appl. No.: 13/863,593

(22) Filed: Apr. 16, 2013

Related U.S. Application Data
(60) Provisional application No. 61/624,656, filed on Apr. 16, 2012.

(51) Int. Cl. G06Q 20/32

(52) U.S. Cl. CPC G06Q 20/3278
USPC 455/41.1

(57) ABSTRACT

A system, network and associated equipment are provided to facilitate the use of short range wireless communication (e.g., near field communication) to facilitate the use of short range wireless communication (e.g., near field communication) to facilitate the collection of money (e.g., donations, tips, change, etc.).

### RELATED APPLICATIONS

The present application claims the benefit of U.S. Provisional Application No. 61/624,656, entitled “Method and Apparatus for Near Field Communication Commerce,” filed on Apr. 16, 2012, which is hereby incorporated by reference herein in its entirety.

### TECHNICAL FIELD OF THE INVENTION

A system, network and associated equipment are provided to facilitate the use of short range wireless communication (e.g., near field communication) to facilitate the collection of money (e.g., donations, tips, change, etc.).

### BACKGROUND OF INVENTION

The present invention is related to Near Field Communication (or similar short range wireless transmission methods), portable communication devices having integrated NFC circuitry, and a network and software to facilitate the use of an electronic equivalent to standard currency (e.g., cash and change) for donations, tipping, purchases of goods, etc. The present invention can be used as a complement to or a replacement for standard currency.

A common method used to collect money (e.g., donations, tips, etc.) by individuals or entities is to provide other individuals a receptacle into which they can place cash or change. There are numerous familiar examples of this common method. For example, churches routinely pass a collection basket during services into which attendees can place donations. As another example, tour guides typically “pass the hat” to tourists at the end of a tour to collect monetary tips. As a further example, individuals at an office may make a collection for one or more employees (e.g., holiday gift for mail person) by circulating a container such as an envelope into which money can be placed. Ordinary artisans and lay people alike will recognize many additional examples of “passing the hat” among a discrete community for a purpose.

Near Field Communication (NFC) is a short-range wireless connectivity technology described in standards such as Ecma-340 and ISO/IEC 18092. Devices equipped with NFC circuitry use magnetic field induction to communicate if touched together or brought within a few centimeters of each other. Numerous companies have proposed using NFC technology to allow smartphone users for example to pay for goods and services at point-of sale readers also equipped with NFC transmitter/receivers. There exist additional technologies that can be used to for electronic payments. For example, the Bluetooth V4.0 low energy protocol is a wireless technique that could be used to transfer giving information wirelessly. Dash 7 (ISO/IEC 1800-7) is another example of short range wireless communication. As another example, Zoosh is technology using inaudible sonic waves to allow devices to communicate in close proximity. One of ordinary skill in the art will be familiar with these short range wireless technologies, all of which can be used in the present invention.

Today, there are NFC networks allowing for the purchase of goods and services (e.g., phones equipped with NFC circuitry and Google Wallet software used at merchants with NFC equipped check outs such as kiosks). However, stationary kiosks are generally unsuitable for communal giving, tipping, etc. as described above (e.g., “passing the hat.”)

In addition to stationary kiosks, smartphones (or tablets) enabled with NFC technology can communicate with other NFC-enabled devices and thus transfer funds. While these computing devices are portable, it would be unseemly to pass around, for example, an iPad during church services. In addition, personal portable devices such as smartphones and tablet computers are relatively expensive and include a number of personal features (e.g., email, text messages, etc.), making it unlikely that people would want to “pass” them around for purposes such as tipping. Moreover, such devices are unsuitable for collecting standard currency.

Further, existing NFC software applications such as the Google Wallet Application are designed to operate like a credit card transaction. Such applications therefore do not provide a user the option of paying for goods and services electronically while retaining some of the feeling of paying for goods and services with standard physical currency. In addition, there exists no prior art solution enabling a consumer to pay for goods and/or services with physical currency and then to receive some or all of the change virtually via short range wireless communication.

Thus, there exists a need for receptacles (e.g., church collection plates) equipped with NFC technology (or comparable technology) to allow members of a group to communally give money in addition to or as an alternative to the standard giving of currency. There also is a need for portable receptacles that can be configured to receive donations for a particular charitable organization or entity that may allow the donor to track donations for tax deductions or other purposes and allow control of how the donations are used by the donee. There also exists a need for supporting hardware and software including servers and point-of-sale terminals such as cash registers (as appropriate). Similarly, there currently is no network or associated software allowing easy donation/tipping/etc. when the “hat is passed.” Further, there is a need for software that maximizes the benefits of NFC technology (e.g., the ability to pay or obtain change in various currencies and the security of not needing to carry physical currency at all). In other words, there is a need to provide a user the option of selecting the method of payment or donation (e.g., giving physical and/or virtual money in one or more selected currencies to a vendor or service provider) and selecting the method of receiving change (e.g., in physical and/or virtual money form in one or more selected currencies).

### BRIEF DESCRIPTION OF DRAWINGS

FIG. 1 is an exemplary network using the NFC-enabled receptacle of the present invention.

FIG. 2 is illustration of an exemplary receptacle for the collection of traditional currency and electronic cash via NFC technology.

FIG. 3 is an illustration of a wireless communications module for use with the exemplary collection receptacle.

FIG. 4 is an exemplary user interface running on (for example) a smartphone that allows giving electronic cash or paying for goods and services with electronic cash.

### DETAILED DESCRIPTION

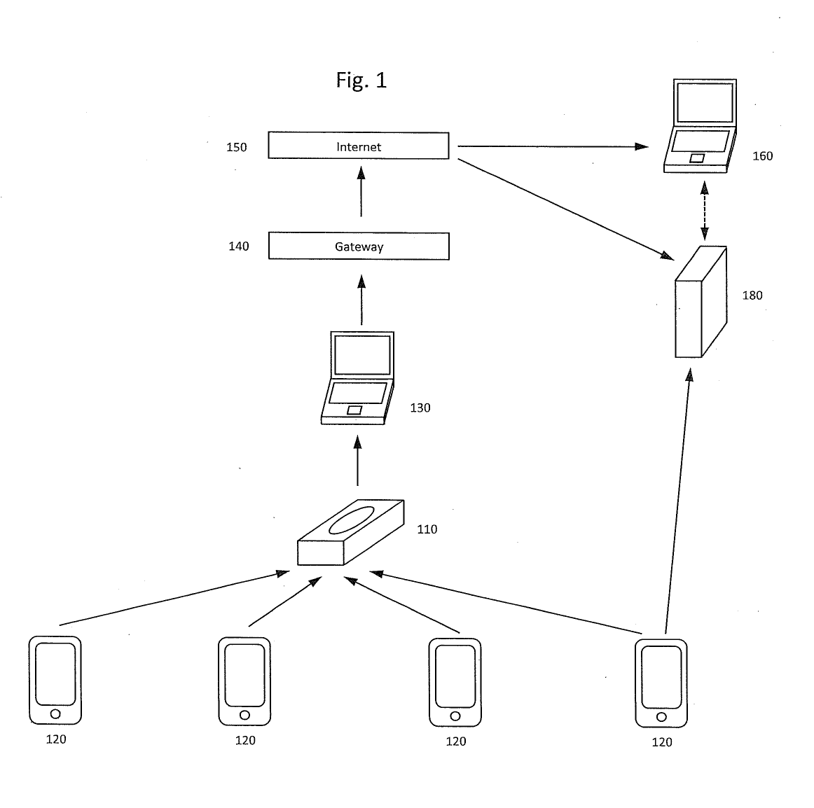

FIG. 1 illustrates an exemplary network useful with the present invention. For purposes of illustration only and to facilitate understanding, the network is described in the context of church collection. One of ordinary skill in the art, however, will understand that the network can be used for any giving including, but not limited to, charitable donations or tipping.

In FIG. 1, communication network 100 includes one or more receptacles 110 that, in an exemplary embodiment, are equipped with NFC technology. Optionally, the receptacle 110 also includes circuitry allowing it to communicate wirelessly with an access point (via, e.g., 802.11 technology) or, alternately, with a cellular base station. As a further option, receptacle 110 may also include, for example, USB circuitry and a USB connection port so that it can communicate with another computer via a USB connector. For purposes of illustration, the receptacle 110 is a church collection basket that is passed during church services for the purpose of collecting currency and electronic donations. As will readily apparent to one of ordinary skill in the art, the receptacle 110 could be used for donations/giving in many other for profit and not-for-profit settings.

The network also includes one or more smartphones 120. In the present example, some or all of the churchgoers will have smartphones equipped with NFC circuitry. When equipped with software (as described below) or, alternately, third party software such as Google Wallet, the churchgoers will be able to give money “into” the receptacle along with churchgoers that choose to place standard currency in the receptacle. While FIG. 1 shows an exemplary smartphone 120, one of ordinary skill in the art will recognize that other mobile/portable devices could be used as well such as tablet computers, etc. so long as the devices also have NFC (or similar) capabilities.

A computing device 130 is coupled (wirelessly or via wireless) to the receptacle 110. In one embodiment, the computing device 130 is a computer into which information regarding donations may be transferred from the receptacle via, for example, a USB connector. Moreover, computing device 130 will preferably include software that registers the receptacle 110 of the present invention with the appropriate organization (e.g., church) and creates passwords for that receptacle for security purposes. In an exemplary embodiment, the receptacle 110 could be sold pre-packaged with a default password that could optionally be changed to an organization-defined password when the receptacle is registered with appropriate organization. In another exemplary embodiment, the receptacle 110 would require creating a new password upon registration, initialization, or first use. One of ordinary skill in the art will understand that there are numerous techniques for setting passwords in the prior art that could be used with the receptacle of the present invention. Moreover, as one of ordinary skill in the art will recognize, most commercially available computers (e.g., laptops, desktop computers, etc.) include a USB port and associated USB hardware/software. In an exemplary embodiment, computing device 130 will also be equipped with an Ethernet port to allow it to be connected to a network.

In another exemplary embodiment, the computing device 130 may include and/or be an 802.11 access point that communicates with the receptacle wirelessly. In this embodiment, an organization could optionally register receptacles wirelessly and also transfer information concerning donations and donors wirelessly. As one of ordinary skill in the art will recognize, the 802.11 access point can be coupled to the Internet typically via an Ethernet connection, allowing information to be transmitted to, for example, a bank.

The computing device 130 is coupled to a gateway 140 that provides access to a network 150 such as the Internet. The network is connected to a computing device 160 that runs banking software 170. As will be understand by one of ordinary skill in the art, the banking software 170 may be used to input electronic donations from the receptacle into the appropriate organization's (e.g., the church's) bank account. One of ordinary skill in the art will understand that there are many prior art banking software packages that receive and manage electronic funds for bank customers.

In a further exemplary embodiment, computing device 130 may have both 802.11 and cellular capabilities if it were connected to, for example, a Novatel MiFi device. In this exemplary embodiment, the computing device 130 could transfer data received from the receptacle 110 to a cellular network. In that embodiment, the computing device 130 will be able to communicate with an optional cellular base station 130A.

In an exemplary embodiment, information associated with the donor originating at the receptacle 110 or at the smartphone 120 may also (but need not) be transmitted via the network 100 to server 180. Server 180 can be either integrated with or separate from computing device 160. Server 180 can include Giving Management Software 200. In alternative embodiments, Giving Management Software 200 may reside on the smartphone 120, on the receptacle 110, on other devices in the network, or be distributed between the smartphone 120, the receptacle 110 and/or other devices including the server 180. In an exemplary embodiment, Giving Management Software 200 will transfer information concerning donations and other forms of giving into databases associated with registered users. Server 180 may receive this information directly from computing device 130 or smartphone 120, or alternatively, may receive this information from computing device 160. In an exemplary embodiment, Giving Management Software 200 would generate reports periodically (annually, monthly, etc.) for tax purposes concerning charitable giving to organizations using the receptacle for the present invention. Such reports would allow a church, for example, to track electronic donations at particular services, frequency of electronic donations, etc. As another example, the Giving Management Software 200 may generate a report indicating the amount a particular donor donated so that the donor could deduct the donations on his income taxes.

Donors may be hesitant to donate significant amounts of money to certain donees (e.g., panhandlers, street musicians, etc.) because the donations may not be tax deductible and the donor may worry that the donation will be used for improper purposes. See, e.g., http://news.change.org/stories/why-you-shouldn-t-give-money-to-panhandlers. In one embodiment, the donee may be provided with a NFC enabled receptacle or a wireless communication enabled receptacle using technologies that are known to those of ordinary skill in the art (e.g., Bluetooth, 802.11, etc.) that receives donations from a NFC and/or wireless enabled device (e.g., smartphone 120). For example, the receptacle 110 may be configured to receive virtual donations from a donor that are placed into an account (e.g., a bank account, credit card account, debit card account, etc.) for the donee. The account may be a regular bank account that gives the donee the freedom to use the donation as he or she pleases using banking software 170, an account that only allows the donee to spend the donation on one or more approved goods or services (e.g., food, clothing, medical services, health insurance, etc.), and/or an account that only allows the donee to use the donated funds with a particular vendor or service provider (e.g., a food pantry of a charitable organization, a low income health clinic, etc.). For example, the donation may go to a debit card or prepaid credit card, or a gift card for a particular vendor or particular goods or services linked to the account.

In some embodiments, the use of the donation may be controlled by providing access codes only to approved vendors that allow a donee to access and use funds from the donee's account or card. For example, in an embodiment where the donation is put on a debit or credit card account for the donee, the donee may be restricted to using the funds to purchase goods or services from particular vendors with an appropriate access code. Using the same technology that is currently available for making purchases with a debit card requiring a secret code to access funds in the account, the secret code may be provided by the vendor instead of the purchaser (i.e., donee). Thus, the donee can only use the donation to buy goods or services from a vendor who has the proper access code to access funds in the donee's account. In another embodiment, to provide security to the donee, a portion of the overall code required to access funds in the account can be partially provided by the donee and another portion of the access code can be provided by the vendor. As an example, two separate access codes, one from the donee and one from the vendor may be required to process a transaction with funds from the donee's account.

In another embodiment, the donation may be put into an account that can only be accessed at a particular store or group of associated stores that sell approved goods. For example, using the same technology that is currently available to purchase physical or virtual gift cards redeemable only at a certain store or related group of stores (e.g., http://www.giftsms.com.au, http://www.giftrocket.com, etc.), the donation may be put into an account that can only be accessed or used at approved stores.

In another embodiment, the donations may be used only to purchase approved products and services (e.g., food and medical care). For example, using procedures and technology that is currently used for government food stamp programs and EBT cards, the purchase of alcoholic beverages using funds in a donation account may be prohibited. In another embodiment, the UPC codes or other codes that are typically scanned when an item is purchased can be compared to a database of codes for approved items. If the scanned item is not on the approved item list, the vendor may receive an automatic notification or an alarm using current techniques known in the art. In an alternative embodiment, when the item to be purchased is not on the approved list, the transfer of funds from the account or card may be blocked or frozen until the unapproved item is removed or the account is reset. For example, the same technology that is currently used to block a credit or debit card purchase when the credit limit is reached or when there is an account balance of $0 can be used to block the purchase or freeze the account when a donee attempts to purchase an unapproved item.

As another example, when parents give children traditional credit or debit cards for use at college or for emergencies, there is typically no mechanism to prevent the child from making charges on the cards other than setting a credit or spending limit. While some existing debit and credit cards (e.g., Discover Current Credit Card, Visa Buxx, etc.) may provide online tracking and “after-the-fact” parental controls by issuing email notifications to parents when a questionable purchase is made, by using the techniques of the present invention that place restrictions on the use of funds from an account, controls can be placed on an account that prevent a child or donee from using the account or card for inappropriate purposes.

In other embodiments, different types of controls may be applied in combination to the same account to restrict the use of funds in the account. For example, using embodiments of the present invention, a donee may be restricted to purchase only an approved subset of the products available from an approved vendor. As an example, if an approved vendor sells food and alcohol, the account could be configured to only allow purchases of food from the vendor using the present invention.

In an exemplary embodiment, the donated funds may come from a tax deductible charitable trust (e.g., http://www.fidelitycharitable.org/giving-account/features/how-it-works.shtml). Donations from a charitable trust may only be given to organizations that are approved by the United States Internal Revenue Service (IRS), or similar governmental entities in other countries. In this embodiment, the controls placed on an account may restrict the donee to using the donations to purchase goods or services from vendors that are approved for receiving funds from charitable trusts.

In certain embodiments, the receptacle 110 may be in the shape of a device that is typically used to collect donations (e.g., a hat, coffee cup, mug, musical instrument case, etc.). In one embodiment, the receptacle 110 includes a transceiver that can receive and send data. For example, the receptacle 110 can receive data from a donor about the donation and the receptacle can transmit data to the network. In another embodiment, the receptacle includes only a transmitter that transmits account information or other identifying information (e.g., a code that identifies an account number in an account database). For example, the receptacle may transmit account identifying information to a donor user device (e.g., smartphone) or network using wireless or near field communication protocols known to one of ordinary skill in the art. The user device may use software and hardware to allow the donor to deposit funds in an account using the account identification information. In another embodiment, the donee provides account identification information that can be read by the donor user device. For example, the account information may be read using a reader application on a smart phone (e.g., QR code reader, bar code reader, etc.). In another embodiment, the user device may read the account identification information using text recognition to interpret text in an image that was taken with a camera. In yet another embodiment, the account identification information can be entered manually using a user interface on the donor user device or receptacle. In another embodiment, the account identification information can be specified using voice recognition software.

In a further alternative embodiment, computer 130 is unnecessary if instead its functionality is provided via cloud based computing services that could, for example, be provided by server 180. In that scenario, an organization such as a church would not need to load software associated with the receptacles onto the organization's computer(s) but instead would be able to access the same or similar software through cloud-based computing via the internet. Cloud based management of the receptacles enables real time or near real time data to be transmitted over a network including, for example, a donor's bank. Thus, where a receptacle has cellular and/or 802.11 capability, a bank may be informed in real time or near real time that one of its customers has transferred money to a receptacle. Similarly, once informed, the bank may route confirmation in real time or near real time back to the receptacle that in turn may communicate the confirmation to a donor's portable communication device via short range wireless communication in real time or near real time. Alternately, the bank may also transmit confirmation to a user's registered email and/or SMS in real time or near real time.

Similarly, in an exemplary embodiment, Giving Management Software 200 could also generate a report and then transmit that report to donors/givers (e.g., a registered email account) that included, for example, information relating to charitable donations, tips and other forms of giving. This report could be used by a donor to claim charitable deductions for tax purposes, and also to periodically check his or her total charitable donations. In an optional embodiment, a donor will be able to input his or her estimated annual income in his or her computing device via the Giving Application (described further below) so that the report can indicate an estimated tax benefit associated with a donor's giving. The report also would be useful for expense report generation purposes within a company and for reporting business expenses at tax time where an individual gives, for example, electronic tips in the receptacle. In another embodiment, a user of the system of the present invention could request that pertinent information stored in the server 190 be transmitted (electronically and/or as a paper record) periodically to a tax professional or tax accounting software (e.g., Turbo Tax). In certain embodiments, software on server 190 will encrypt all tax information prior to transmission to a third party such as an accountant.

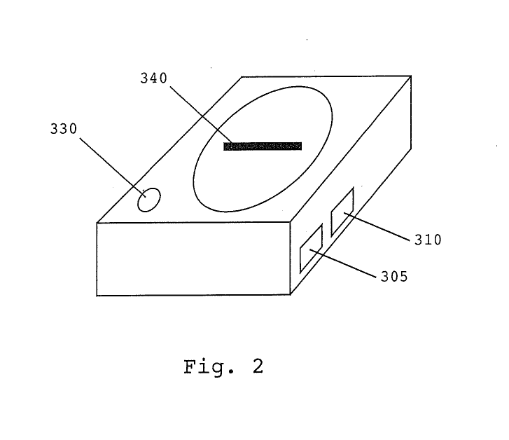

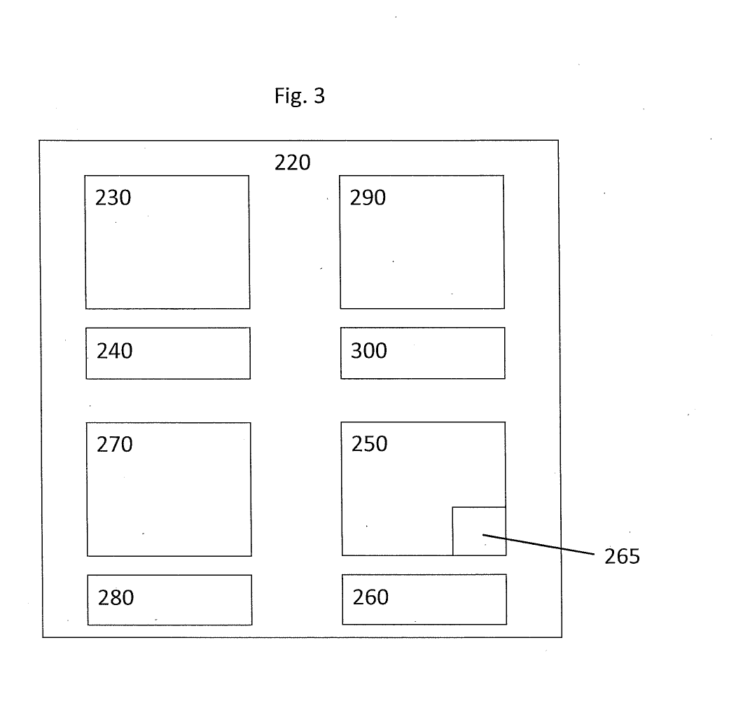

FIG. 2 illustrates an exemplary receptacle 210 for the present invention. As illustrated, the receptacle 210 is shaped like a dish or basket typically used, for example, for church collections. In this embodiment, the dish/basket shape allows the collection of standard currency when the dish is passed at a church collection for example. The dish/basket shape also conveys the message that it is intended for the collection of donations, and preferably would be similar in appearance to prior art receptacles. In an exemplary embodiment, the receptacle 210 is made from plastic. One of ordinary skill in the art will recognize that other materials can be used to construct the receptacle so long it can house the Wireless Communication Module 220 (depicted in FIG. 3 and discussed further below).

In an exemplary embodiment, the Wireless Communication Module 220 of FIG. 3 will be integrated in the receptacle 220 such that it is not removable without destroying (tearing down) the receptacle. Integrating the Wireless Communication Module serves the purpose of maintaining a more traditional appearance for the receptacle 220. Of course, one of ordinary skill in the art will understand that the receptacle 220 could be designed so that the Wireless Communication Module 220 could be removed and, for example, replaced with a newer model.

While the receptacle 210 is illustrated as dish or basket shaped in an exemplary embodiment, it can have any shape suitable to collect standard currency. For example, the receptacle 210 could be constructed to look like a standard tip jar with the Wireless Communication Module 220 housed in the lid of the jar. Further, the lid of the jar could (but need not) include a slot for the insertion of standard currency into the tip jar. Moreover, in another embodiment, the receptacle 210 may be a flat or substantially flat plate to be passed among a group for the purposes of giving. That exemplary embodiment may be used in situations where an organization (profit or not-for-profit) expects that users will give little (or no) standard currency, making it desirable to have a receptacle that is more compact.

The receptacle 210 houses a Wireless Communication Module 220, and example of which is depicted in FIG. 3. Wireless Communication Module 220 includes a processor 230 and memory 240. One of ordinary skill in the art will understand that processor 230 could include a single commercially available microprocessor chip or multiple chips.

Memory 240 can be non-volatile and volatile memory. Non-volatile memory suitable for the present invention includes any of PROM, EPROM, EEPROM, Flash memory, or some combination thereof. Volatile memory suitable for the present invention include, for example, SRAM, DRAM, SDRAM, or some combination thereof.

The memory 240 and processor 230 respectively store and execute instructions to allow NFC communications (or similar short range communication). Memory 240 may also store registration information concerning the organization using the receptacle 210 and the individuals that give electronically to the receptacle. Moreover, the memory 240 will store instructions for USB communications and 802.11 (WiFi) and/or cellular communication (as appropriate). One of ordinary skill in the art will understand that suitable instructions are widely commercially and publicly available.

The NFC Module 220 will also include an NFC transceiver 250 coupled to an NFC antenna 260 to allow the receptacle to communicate with, for example, an NFC-equipped smartphone. One of ordinary skill in the art will recognize that NFC transceiver and antenna could be replaced with a similar alternative transceiver and antenna without departing from the spirit of the present invention. The NFC Module will also have an internal power source 265 (e.g., a rechargeable battery) and optionally a power management circuit.

In another embodiment, the Wireless Communication Module will also include an 802.11 transceiver 270 and associated antenna 280. The Module may also (but need not) include cellular transceiver 290 and antenna 300. As discussed above, this optional hardware allows the receptacle to communicate with an 802.11 access point and/or a cellular base station to, for example, transfer electronic donations to a bank account as described above. Referring back to FIG. 2, if the receptacle 210 includes cellular functionality, in an exemplary embodiment, the receptacle 210 will include a SIM card 305 which will identify the receptacle 210 to the cellular network.

The optional cellular transceiver and antenna where donors give to one or more receptacles outdoors, and an organization desires that donations reach a bank account quickly. Ordinary artisans and lay people alike will be familiar with such applications. For example, every Christmas season individuals dressed as Santa Claus collect donations outdoors for various charities. Similarly, valets at a parking garage may collect tips (standard currency and electronic tips) by placing the receptacle 210 outside the valet stand. As a further example, street musicians could use receptacle 210 to collect donations/tips.

As further depicted in FIG. 2, receptacle 210 may also include USB port 310 and associated USB circuitry 320 (not shown). When connected via a USB connector to an external power source (e.g., a wall outlet), the USB circuitry can be used to recharge the internal power source 265 shown in FIG. 3. In addition, when connected via a USB connector to another computing device such as the computing device 130, the user of the receptacle will be able to make a wired transfer of data (e.g., funds donated, identifying information for donors, etc.). The USB port and circuitry therefore provide a way to transfer data from the receptacle when wireless communication is either not available or not desired by the user of the receptacle. While USB circuitry is used in the exemplary embodiment, one of ordinary skill in the art will recognize that there are numerous alternatives to USB such as FireWire. In another embodiment, the receptacle 210 will include a plastic cover (e.g., hinged or sliding) that will obscure the USB port from view except when it is in use.

In an exemplary embodiment, the Wireless Communication Module 220 may also include one or more universal asynchronous receiver/transmitter (UART) interfaces. The UART interfaces translate data received/transmitted by the transceivers in the receptacle (e.g., the NFC transceiver and optional 802.11 and cellular transceivers).

In an exemplary embodiment, the receptacle 210 will also include a feedback device 330 coupled to the Wireless Communication Module 220. The feedback device 330 will notify a donor/giver that he or she has successfully completed a transaction. In one exemplary embodiment, the feedback device may be a green (or other suitably colored) light bulb that could light up upon completion of a successful donation. In another exemplary embodiment, the feedback device could be an electronic chime/sounder, providing a simple chime indicating the completion of a successful donation. Alternately, the electronic chime/sounder could play an excerpt of, for example, Christmas music upon completion of a successful donation. In another exemplary embodiment, the feedback device could be a relatively small liquid crystal display that could display words such as “Bless You” or “Thank You” upon completion of a successful donation. One of ordinary skill in the art will recognize that the above forms of visual and audible feedback could be combined, and that other types of feedback devices could be used as substitutes.

In the embodiment in which the feedback device is an LCD, the processor 230 can execute instructions to keep a running tally of total donations that can be updated on the LCD in realtime. For example, a school could pass the receptacle 210 at a Parent Teacher Association meeting in which the parents are asked to raise a certain amount of money for, for example, a class trip. As the receptacle is passed, the parents would be able to see with each successive donation how close they were to reaching a goal.

Relatedly, if it is desirable to obtain an exact real time tally of standard currency and electronic giving/donations, receptacle 210 can also include a slot 340 (in, for example, the lid of a tip jar) equipped with optical currency recognition module 350 (not shown). There exists portable currency recognition hardware for blind and visually impaired individuals. One example of a commercially available optical currency recognition module is the Brytech NoteTeller described at http://www.brytech.com/noteteller. The optical currency recognition module could inform the processor 230 of the denomination of currency as it is input in slot 340.

In another exemplary embodiment, the receptacle 210 determines properties associated with donations for calculating additional analytics. For one or more donations, software stored in memory 240 executes to measure properties such as the amount of a donation, the location of the receptacle where a donation was given, and the time a donation was given. This information can be used to help determine the optimal time, placement, and number of receptacles 210. One of skill in the art would recognize that there exist many additional properties that could be measured and the benefit of accumulating the data associated with the properties for analytics.

Relatedly, in another embodiment, a donor can elect to share his or her name and/or contact information associated with a donation. The user specifies his or her name and/or contact information using the Giving Application. By optionally sharing his or her personal information, the user can elect to be included in the social/networking circle of other like-minded donors. As one non-limiting example, the attendees at a political event who donated to the receptacle and identified themselves (either using their actual name or a profile) would be an example of a social network—the members of which being able to subsequently interact with each other using well known social/networking platforms. Such networks could be linked together to create larger networks—e.g., attendee of political rally and school fundraiser in two separate networks linked together by the attendee—where members can elect to interact with one another. Two examples of social networking platforms are Facebook and Google+. Ordinary artisans and lay people alike will recognize other additional social/networking platforms exist and interfacing them with the Giving Application is within the knowledge of one of skill in the art.

In another embodiment, the receptacle can further include location-based functionality (e.g., GPS circuitry and decoding logic) to enable a further social/networking aspect. In an exemplary embodiment, the receptacle can be used for, for example, “Walk-a-Thon” for one or more causes in which one or more users will transport the receptacle(s) to different locations to solicit and collect donations. In this exemplary embodiment, donors will share at least their name (or profile) when making a donation to the receptacle. In another embodiment, where multiple users are transporting the receptacle over time, the receptacle can also record identifying information (e.g., name or profile) for the individual who solicited a particular donation or donations. In another embodiment, donors will have the option of identifying themselves as anonymous. Via the location-based functionality (e.g., GPS circuitry), the receptacle will also track the location for particular donations. In another exemplary embodiment, donors can contribute to one or more causes without the need for a receptacle by interacting with a smartphone, tablet, or similar device running the Giving Application. As described above, in addition to the amount of donations, the identifying information and location-based information can be transmitted from the receptacle (via a USB connection, WiFi network or cellular network) to the server 180.

After the information in the receptacle reaches server 180, using, for example, well known social/networking platforms, interested parties will be able to view any combination of the total amount donated to a particular receptacle, where the receptacle has traveled, who donated to the receptacle, and who solicited a particular donation. One of ordinary skill in the art will recognize other information that could be collected and displayed to interested parties. As described above, donors will be able to elect to be included in the social/networking circle of other donors to the particular receptacle.

In another embodiment, the Giving Management Software could provide a map (e.g., a Google Map) with pinpoints illustrating donors to the receptacle and connections between those pinpoints illustrating the physical path taken by a particular receptacle while collecting funds. As a further option, each pinpoint may be linked to a social/networking profile associated with a particular donation (e.g., a Facebook page), allowing a donor to communicate with other individuals with social/networking profiles including other donors, the individual(s) transporting the receptacle, the charitable organization associated with the receptacle. Moreover, one of ordinary skill in the art will understand that information concerning the physical path of the receptacle can be conveyed through different user interfaces (e.g., 3-D maps, etc.).

In another embodiment, the Giving Management Software will also present a leader board to interested parties in a user interface, illustrating the money gathering progress of a plurality of receptacles associated with a particular cause. As will be appreciated by one of ordinary skill in the art, the leader board could be presented in a number of ways including bar charts, a spreadsheet including dollar amounts, etc. In this embodiment, interested parties will be able to view the location-based path of all receptacles as described above by selecting receptacles represented on the leader board. Further, in this embodiment, the networks associated with each of the plurality of receptacles will also be linked together so the donors in the plural networks will be able to interact with one another if they choose to do so (via, for example, Facebook pages).

In cases where the receptacle is transported over relatively long distances to solicit donations, used outside for relatively long periods, etc., the charge on the battery in the receptacle may become low during use. In another embodiment, the receptacle may be equipped with one or more solar panels that convert solar energy to electrical energy in order to recharge the battery during transportation. One of ordinary skill in the art will recognize that there are many types of solar panels including, but not limited to, photovoltaics and photovoltaic arrays. Moreover, additional alternative energy sources such as kinetic electric energy, piezoelectric technologies, etc. could be employed in the receptacle in order to provide alternatives for recharging the battery. One of ordinary skill in the art will understand that it is not necessary for a receptacle to be transported over long distances in order to benefit from the alternative energy sources described herein.

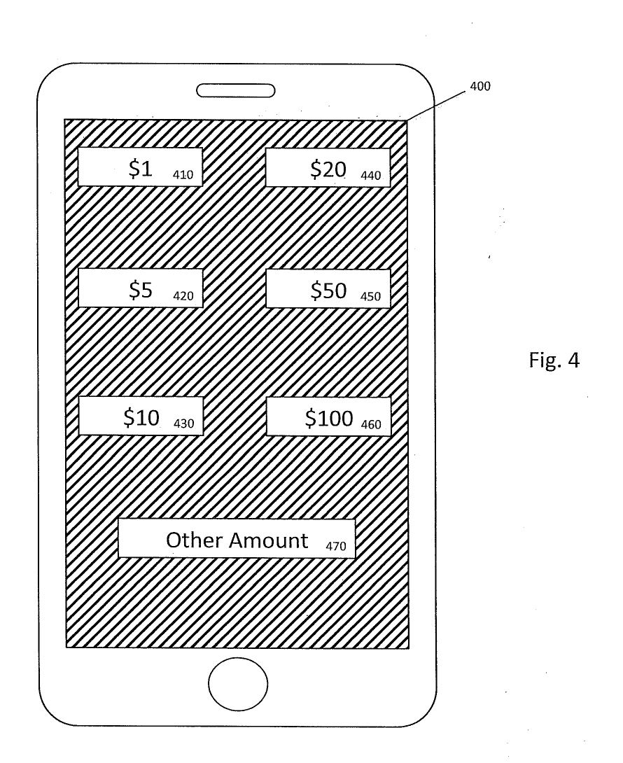

FIG. 4 illustrates an exemplary user interface for a Giving Application loaded on a smartphone or tablet computer to be used with the present invention. The user interface is designed to provide a similar experience to the traditional method of giving standard currency in a communal giving situation. User interface is displayed on screen 400 of, for example, a smartphone. Screen 400 could be a touchscreen (capacitive or resistive), a screen where icons are manipulated by a keyboard/trackpad controlled cursor or both.

In an exemplary embodiment, screen 400 will include icons 410-460 that in an exemplary embodiment are designed to look like standard currency. In the exemplary embodiment, icons 410-460 appear to be $1, $5, $10, $20, $50 and $100 bills. Icon 470 will be a button stating, in an exemplary embodiment, “Other Amount.” As will be apparent to one of ordinary skill in the art, the arrangement of icons is similar to the interface on a stationary automated teller machine for withdrawal of cash.

In the event that a user selected icon 470, a separate interface such as a pop up would appear to the user. This separate interface would allow a user to input an exact amount of money.

In an exemplary embodiment, a user will be able to customize the Giving Application. For example, the Giving Application will include software providing for a registration/customization interface allowing the user to link one or more bank accounts or another source of funds to the Giving Application. The registration/customization interface may also (but need not) allow a user to ratchet up or down the denominations of currency to match his or her giving preferences, changing the appearance of icons 410-460. For example, icons 410-460 could be changed to be 0.10 c, 0.25 c, $1, $5, $10 and $20. Alternately, icons 410-460 could be changed to $10, $20, $50, $100, $200 and $500. In the event that a user chose to include change in his interface, the icons corresponding with change would preferably be circular and icons corresponding with paper currency would be rectangular.

In one exemplary embodiment, when a smartphone user sees the receptacle 220 being passed, he or she can activate the Giving Application. Prior to receiving the receptacle 220, the user would select one of icons 410-460 (or icon 470) by touching the screen (if the smartphone has a touchscreen), by manipulating the keypad, etc. In another embodiment, a separate interface (e.g., a pop up) provided by the Giving Application could ask the user to confirm the selected denomination. When the user receives the receptacle 220, he or she can tap or bring the smartphone near to the receptacle 220, and the selected denomination will automatically transfer the funds electronically to the receptacle. Once the donation/giving is completed, the user preferably will be provided feedback on the computing in addition to the feedback that also can be provided on the receptacle 210. In another embodiment, the feedback would be a sound associated with money played through the speaker in a smartphone, tablet, etc. (e.g., money being counted in a bank, etc.).

Alternately, in an exemplary embodiment, when a computer (e.g., smartphone) loaded with the Giving Application touches or is brought close enough to the receptacle 210 to initiate near field communication, the screen 400 would appear to a user. The user would then select the donation amount by selecting one of icons 410-460 (or icon 470) by touching the screen (if the smartphone has a touchscreen), by manipulating the keypad, etc. In an alternative embodiment, the Giving Application could use speech recognition software (e.g., Apple's SIRI technology) to allow a user to say the amount of currency to select one of icons 410-460. In another embodiment, a confirmation screen (e.g., a pop up) will appear after one of icons 410-460 is selected, asking a user to confirm that he or she wants to donate the selected amount. Once the donation/giving is completed, the user preferably will be provided feedback on the computing in addition to the feedback that also can be provided on the receptacle 210.

Alternately, in an exemplary embodiment, the user can choose between one of many organizations that should receive the designated donation. In another embodiment, a separate interface is provided by the Giving Application to ask the user to designate one or more default organizations. When the user receives the receptacle 220, he or she can chose from one or more of the pre-configured organizations to designate as the recipient(s) of the donation. In another embodiment, when the user initiates a donation with a receptacle 220, the Giving Application will present one or more organizations or causes for the user to select from. The organizations or causes can be pre-configured by the administrator of the receptacle 220 or be influenced by other donators. For example, a donor can suggest one or more organizations or causes for consideration and future donors will have the option of selecting the newly recommended organization or cause.

In another embodiment, using the user interface and the Giving Application, the donor can restrict the donee to use the donation to purchase goods or services from approved vendors or service providers. For example, the funds donated could be configured to be used to purchase goods or services only from IRS approved organizations so that the donations can come from a charitable trust. As another example, donations could be configured to be used to purchase goods only from vendors that do not sell certain types of products (e.g., alcoholic beverages).

In one embodiment, the donor can enter information for the designated approved vendors or service providers manually using text entry or audibly by using voice recognition software. In another embodiment, a separate interface is provided by the Giving Application to ask the user to select one or more approved vendors or service providers from a list of default options. In another embodiment, the donor may use the user interface to select the types of approved goods and services that can be purchased using the donated funds instead of or in addition to the approved vendors and service providers. In alternative embodiments, the user interface and the application to allow the user to select approved vendors and service providers and/or approved products and services resides on the donor device (e.g., smartphone 120). In another embodiment, the user interface and application is distributed between the donor device and the receptacle 110 and/or other network devices that may be used to configure the characteristics and restrictions on the donations.

When the user receives the receptacle 220, he or she can chose from one or more of the pre-configured organizations to designate as the recipient(s) of the donation. In another embodiment, when the user initiates a donation with a receptacle 220, the Giving Application will present one or more organizations or causes for the user to select from. The organizations or causes can be pre-configured by the administrator of the receptacle 220 or be influenced by other donators. For example, a donor can suggest one or more organizations or causes for consideration and future donors will have the option of selecting the newly recommended organization or cause.

In another embodiment, the Giving Application may also be used for the purchase standard goods and services, and optionally create a Virtual Change Jar. For example, the registration/customization interface of the Giving Application described above could also allow a user to set his or her phone to use the Giving Application for all monetary near field communication transactions (in the alternative to, for example, Google Wallet). In a further exemplary embodiment, the registration/customization interface of the Giving Application described above could be allow a user to set his or her, for example, smartphone to use the Giving Application for monetary near field communication transactions at certain types of merchants (e.g., grocery stores). By so configuring his or her device, a user could maintain the feeling of paying cash for goods and services when using NFC (or equivalent) technology.

In a further embodiment, a user will be able to configure how much “change” is placed in the Virtual Change Jar. Because the user interface of the Giving Application provides for standard currency amounts, there will be situations where the push of a single icon on the user interface 400 to purchase a good or service will result in more change than a fraction of a dollar (e.g., tapping a $10 icon representing electronic currency to pay for an $8.50 product). In such situations, in the exemplary embodiment, the user will have the option of placing all the change in the Virtual Change Jar (e.g., $1.50 in the above example) or only the “coins” (e.g., 0.50 c in the above example). Where a user does not wish to donate only “coins” to the Virtual Change Jar, in a preferred embodiment, the whole dollar change (e.g., $1.00 in the example above) will be either re-credited to the bank account associated with the Giving Software or alternately not deducted at all. After reading the present disclosure, one of ordinary skill in the art will recognize that there are numerous additional ways to customize the Virtual Change Jar (e.g., placing up to $3.00 worth of change in Virtual Change Jar and returning remainder to bank account, etc.)

Moreover, when paying for goods and services (e.g., groceries, clothing, etc.) with the electronic equivalent of cash, users of the Giving Application will generate virtual change. In another embodiment of the present invention, the Giving Application can include a Virtual Change Jar into which all electronic change is stored for a user specified period of time (e.g., weekly, monthly, annually or indefinitely). In a further embodiment, the Giving Application could provide a user the option of placing some of his or her change in the Virtual Change Jar and some of the change in an interest bearing saving account separate from the user's bank account (such as a 529 College Saving's Plan for a users children).

In a further exemplary embodiment, the Giving Application could offer multiple Virtual Change Jars to users associated with various prizes (vacations, dinners, consumer electronics, etc.). A user could select a Virtual Change Jar associated with a particular product that has a particular price. As described above, the user could donate some or all of his or her change toward obtaining a particular prize. Once the amount of electronic change in the Virtual Change Jar matched the price, the user could redeem the prize (e.g., by receiving a gift certificate, travel voucher, etc.). In another embodiment, in order to offer discounted prizes, the electronic change could be placed in an interest bearing account until the price of the prize is reached with the interest being distributed in whole or in part to the entities that provide prizes.

In another exemplary embodiment of the present invention, the Giving Application may be configured so that some or all of the Virtual Change Jar is added to whichever of the icons 410-460 is selected when a donation is made. As a non-limiting example, when a churchgoer taps his smartphone and selects one of icons 410-460, a pop up window could ask the user if he or she also wanted to donate some or all of his or her Virtual Change Jar to the church. Alternately, the user could configure the Giving Application to recognize a receptacle associated with his or her church (or any other entity) and, in addition to whatever denomination selected in icons 410-460, to automatically donate (“empty”) the Virtual Change Jar whenever his or her smartphone comes in contact with a receptacle registered with his or her church.

In a further exemplary embodiment, the receptacle 220 could be used to collect for an individual or group (e.g., an office collection for a sick co-worker). The Giving Application could include a separate interface allowing a donor to enter a message to the donee after making a donation (e.g., “Get Well Soon”). In a further embodiment, the Giving Application could collect all the messages from donors, and enter them into an electronic card ultimately sent to the donee (e.g., to the donee's email address). Moreover, the funds collected in the receptacle 220 could be applied to a gift card (e.g., a iTunes gift card, an Amazon.com gift card, etc.) included with the electronic card.

In another embodiment, the Giving Application may be configurable so that a user may program automatic contributions into account(s) (e.g., a child's college account, a charitable account, etc. under certain conditions. For example, a user may program the Giving Application to cause $100 to be transferred to a child's college account whenever the user spends more than $500 in a predetermined period. As another non-limiting example, a user may program the Giving Application to transfer 7% of all transactions in a period to a transaction. In this embodiment, the Giving Application will provide the user the capability to easily change saving and/or donation preferences on a portable computing device as preferences change.

In another embodiment, the Giving Application may be configured so that a user may elect to accept virtual change when physical money is used to pay for a good or service. In this embodiment, a business entity (e.g., a merchant) would have a point-of-sale terminal such as a cash register or similar device to track transactions and, optionally, to hold cash associated with a transaction.

Like the hardware described above, the point-of-sale terminal would also include a memory, a processor and NFC (or equivalent) components. In an exemplary embodiment, the memory would include instructions (“the Change Application”) and the processor would execute such instructions in order to manage and account for the provision of virtual change in lieu of physical money. In a preferred embodiment, the point-of-sale terminal will have a user interface (e.g., keypad, touchscreen, etc.) allowing a user of the point-of-sale terminal to specify whether a customer has elected to receive physical change, virtual change or a combination of physical and virtual change.

As will be clear to one of ordinary skill in the art, the memory, processor and NFC (or equivalent) technology may be built into the cash register or a standalone computing device coupled to the point-of-sale terminal. An exemplary prior art NFC-enabled cash register is described in U.S. Pat. No. 7,748,618 which is hereby incorporated by reference.

Further, as will be clear to one of ordinary skill in the art, the present invention may be used with any device that is used to track transactions including physical and electronic (e.g., credit card) transactions. For example, certain taxicabs include computing devices (often with touchscreens) that allow passengers to pay for rides with NFC-enabled smartphones. If loaded with the Change Application, these computing devices could also enable passengers to receive virtual change for a ride paid for with physical money or physical change in a local currency when the taxicab is paid with virtual money. For example, a passenger who is arriving in a foreign country without any local currency could pay a taxicab, vendor or service provider with virtual money (e.g., using a NFC-enabled smartphone) an amount that exceeds the cost of the service or goods and receive physical change in the local currency. In another embodiment, a user may convert virtual money into physical money in one or more particular currencies using a portable device (e.g., NFC-enabled smartphone, wireless-enabled smartphone, etc.) through a network (e.g., NFC network, wireless network, etc.) connected to an automated kiosk that dispenses physical currency (e.g., ATM, foreign currency machine, etc.).

The following non-limiting example illustrates how the Giving Application can be used to accept virtual change in lieu of physical currency. For example, if a user pays for an $8.50 product with a ten-dollar bill, he or she could forgo receiving $1.50 in physical monetary change and instead accept virtual change. After the user of the Giving Application had provided a cashier the ten-dollar bill, the Giving Application would register the amount of virtual change by bringing his or her smartphone (or other device) into proximity with the point-of-sale terminal to enable wireless communication. In another embodiment, the user will be notified that the virtual change has been deposited in the Virtual Change Jar by feedback such as a sound (e.g., change falling into a bank) or on the display of his or her device loaded with the Giving Application. The user designates to receive the change from his or her purchase as virtual change by using the Giving Application. As an example, once the user has received the virtual change, he or she can choose to spend it in one of the many ways described above, including those described with respect to the Virtual Change Jar.

Moreover, as will be clear to one of ordinary skill in the art, the amount of virtual change provided in lieu of physical money can be configurable by both the customer and the merchant. For example, the merchant may only offer coins as virtual change rather than both paper currency and coins. Thus, continuing the example above, after paying $10, the cashier would provide $1.00 in physical currency, and the cash register would transfer 0.50 c of virtual change wirelessly. Alternately, the user could request that the cashier provide him or her physical paper currency and also coins as virtual change. In this embodiment where less than the entire amount of change is distributed as virtual change, the cash register would include a user interface allowing the cashier to enter a customer's preference for receiving (or the merchant's preference for distributing) change. As will be clear to one of ordinary skill in the art, the interface on the point-of sale terminal could be a standard keypad or a touchscreen on a computing device.

In an alternative embodiment, a customer may elect to provide some or all of his virtual change associated with a transaction as a gratuity. For example, a customer may wish to give some (or all) of his or her change to a waitress. Similarly, a customer may wish to give some (or all) of his or her change at a coffee shop. The user interface of the Giving Application may allow a user to input preferences for gratuities. For example, a customer might specify that 50% of the virtual change from transactions at all coffee shops (or a particular coffee shop) should be given as a gratuity. As a further example, a customer might specify that he or she tips 20% for all restaurant transactions, and further specify that his or her virtual change should be applied toward some (or all) of the gratuity for a particular meal. Based on the present disclosure, one of ordinary skill in the art will recognize that there are many ways for a user to input his or her gratuity preferences into the user interface of the giving application.

In another embodiment, the virtual change can be converted to from one currency to a different foreign currency. One of skill in the art would recognize that there are multiple electronic methods of converting money between different currencies. In one embodiment, money from multiple virtual change accounts (associated with one or more users) could be converted together to minimize the transaction cost involved in converting currency. In a further embodiment, the balance in a user's virtual change account can be stored in one or more currencies as a hedge to currency fluctuations.

In one embodiment, when a user elects to receive virtual change, the actual amount associated with the virtual change is immediately transferred from the merchant to an account, which may or may not be a bank account, associated with the user. This account may be a bank account configured by the user, an account maintained by the merchant, or an account maintained by the entity that supports the Giving Management Software. In one exemplary embodiment, the Giving Application, the Giving Management Software or a separate module of software performs this accounting including registering, validating, and maintaining accounts for parties such as merchants, users, and donees; keeping track of the balance owed to each party; keeping track of transactions between different parties; keeping track of any interest earned for each account and any account management fees.

In the case where the account is maintained by the merchant or the entity that supports the Giving Management Software, an amount equivalent to the virtual change may, in one embodiment, be transferred to the appropriate user's bank account periodically. As an example, the period may be either by time, such as daily, once a month, etc.; by amount, such as when the amount reaches a set limit, for example $10; or a combination of the two. In one or more of these embodiments, the Giving Application maintains the configuration information for the particular user's accounts that ultimately receive the amount designed as virtual change.

In another embodiment, the Change Application will create an electronic record detailing the goods and services that a customer purchased (an “e-receipt”). In this embodiment, when a customer initiates short range wireless communication with the point-of-sale terminal, the e-receipt will be transmitted along with the customer's virtual change either automatically or if the customer has elected to receive e-receipts (e.g., in preferences in the Giving Application). As will be appreciated by one of ordinary skill in the art, even in situations where an individual provides the exact amount of physical currency associated with a transaction or elects to receive physical currency rather than virtual currency, the customer may still request and receive an e-receipt for the transaction in accordance with the present invention.

As described above, the Giving Application and/or the Change Application may be provided via cloud-based computing. For reasons described above, if the applications are provided via the cloud, a customer or donor's bank may receive real time or near real time notification of virtual change transactions. Likewise, if a customer or donor so elects, the customer may receive real time or near real time confirmation of virtual change transactions via email, SMS, etc.

Coding the required computer software (in, for example, C or C++ computer languages) for the receptacle, the Giving Application and other software would be routine in light of the present disclosure.

In the foregoing description, numerous specific details are set forth to provide a thorough understanding of the present invention. It will be appreciated, however, by one skilled in the art that the present invention may be practiced without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the present invention. For example, the present invention may be implemented in hardware and/or software residing on the receptacle, user device (e.g., smartphone), or network. In other embodiments, the software may be distributed among the receptacle, user device and/or network.

In the foregoing detailed description, systems and methods in accordance with embodiments of the present invention have been described with reference to specific exemplary embodiments. Accordingly, the present specification and figures are to be regarded as illustrative rather than restrictive. The scope of the invention is to be defined by the claims appended hereto, and by their equivalents.

1. A device comprising:
a receptacle having a cavity with an open end;
a processor;
a memory;
an internal power source; and
a short range wireless transceiver.

2. The device of claim 1, further comprising Uniform Serial Bus (“USB”) circuitry and a USB connection port.

3. The device of claim 1, wherein the short-range wireless transceiver is a near field communication (“NFC”) transceiver.

4. The device of claim 1, further comprising an 802.11 transceiver.

5. The device of claim 1, further comprising a cellular transceiver.

6. The device of claim 1, wherein the receptacle is dish shaped.

7. The device of claim 1, wherein the receptacle is jar shaped.

8. The device of claim 1, further comprising a lid for the insertion of standard currency into the receptacle.

9. The device of claim 8, wherein the lid includes an optical currency recognition module.

10. The device of claim 1, further comprising one or more solar panels for charging the internal power source.

11. The device of claim 1 further comprising a feedback device.

12. The device of claim 11 wherein the feedback device comprises a light bulb.

13. The device of claim 11 wherein the feedback device comprises an electronic sounder.

14. The device of claim 11 wherein the feedback device comprises an LCD.

15. The device of claim 1 wherein the memory stores software configured to keep a running tally of donations to the receptacle.

16. The device of claim 1 wherein the memory stores software configured to determine analytics associated with donations to the receptacle.

17. The device of claim 1 further comprising GPS circuitry and decoding logic.

18. The device of claim 1 further comprising one or more UART interfaces.

19. A server comprising:
a processor;
a transceiver coupling via a network the server to one or more receptacles designed specifically to collect money transferred by short range wireless communication;
a memory, wherein the memory stores software configured to money collected by the one or more receptacles.

20. The server of claim 19, wherein the money collected by the one or more receptacles includes donations.
